(19) United States
(12) Patent Application Publication
(10) Pub. No.: US 2006/0032021 A1
(43) Pub. Date: Feb. 16, 2006

(54) Hinge structure, hinge unit having the hinge structure, and container having cover attached thereto with the hinge structure

(75) Inventor: Michihiro Fukuo, Hachioji-shi (JP)

Correspondence Address: KANESAKA BERNER AND PARTNERS LLP, SUITE 300, 1700 DIAGONAL RD, ALEXANDRIA, VA, 22314-2848, US

(73) Assignee: NIFCO INC., Yokohama (JP)

(21) Appl. No.: 11/181,838

(22) Filed: Jul. 15, 2005

(30) Foreign Application Priority Data
Jul. 30, 2004 (JP) 2004-223828

(51) Int. Cl. E05F 1/08

(52) U.S. Cl. 16/298

(57) ABSTRACT

A hinge structure rotatably connects one member to the other member. The hinge structure includes a hinge case attached to the one member; a first cam member; a second com member; an urging device for urging the first member toward one end portion of the hinge case; and a rotary damper including a rotor having a specific rotational resistance relative to a damper main body. The second cam member has a cam surface at an end portion thereof for abutting against a cam surface of the first cam member, and a connecting portion at the other end portion thereof protruding outwardly from an end portion of the hinge case and connected to the other member. One of the rotor and the dumper main body is connected to the hinge case, and the other is rotationally disposed in the hinge case together with the second cam member.

### BACKGROUND OF THE INVENTION AND RELATED ART STATEMENT

The present invention relates to a hinge structure for rotatably connecting one member to another member such as a lid member attached to a container disposed in an automobile such as a cup holder and a small article box. In particular, the present invention relates to a hinge structure having an urging device for urging a lid member in an opening direction or a closing direction to properly hold the lid member in an opened state or a closed state when the lid member rotates by a specific angle. Further, a damper is provided for braking an operation of a rotating member rotating automatically, thereby improving operational performance.

Conventionally, a container such as a small article box and a cup holder is disposed in a center console or an instrumental panel of an automobile. Such a container is provided with a lid member for opening and closing an opening of the container through a flapping movement. Patent Reference 1 discloses a hinge structure having an urging device for rotating a lid member automatically as a device for connecting the lid member to the container.

Patent Reference 1: Japanese Patent Publication (Kokai) No. 2001-173636

As shown in FIG. 13, the hinge structure includes, in hinge cases b with a rectangular cylindrical shape disposed on a lid member a, first cam members c; second com members d engaging the first cam members c; shafts e for connecting the first and second cam members c and d to the hinge cases b and supporting the first and second cam members c and d; and coil springs f for urging the first and second cam members c and d. The first cam members c are disposed in the hinge cases b not to be rotatable and to be slidable along the shafts e. The second cam members d are disposed in the hinge cases b to be rotatable relative to the hinge cases b and to be slidable along the shafts e. Further, the second cam members d have cam surfaces at end portions thereof in a sliding direction for abutting against cam surfaces of the first cam members c, and connecting portions at the other end portions thereof protruding outwardly from ends of the hinge cases b for fitting in a container main body g not to be rotatable.

The cam surfaces of the first and second cam members c and d have a shape formed of several projections connected in a ring shape. The shafts e are aligned with a center line of the hinge cases b, and penetrate through the cam-members c and d for connecting the cam members c and d and the hinge cases b. The springs f are disposed between bottom surfaces of the hinge cases b and the first cam members c, and wind on peripheral surfaces of the shafts e.

In the hinge structure, when the lid member a is rotated by a specific angle to open or close, the first and second cam members c and d convert an urging force of the springs f into a rotational force. Accordingly, the lid member a automatically rotates by a specific angle relative to the container main body g. At the specific angle, the cam surfaces of the first and second cam members c and d engage with each other, thereby holding the lid member a at the specific angle. Therefore, it is possible to automatically rotate the lid member a to open or close when the lid member a is rotated by the specific angle, and stably hold the lid member in an opened state or a closed state.

In the hinge structure, however, the lid member is not necessarily opened or closed with satisfactory operational performance. That is, with the urging force of the coil springs f and the cam function of the first and second cam members c and d, the lid member a rotates at a relatively high speed due to the urging force of the coil spring, thereby deteriorating operational performance. Depending on an application, the lid member a rotating at a relatively high speed may cause a problem. For example, in a case of an ash tray, when the hinge structure is opened or closed at a high speed, ash or a cigarette end may scatter due to an impact.

In view of the problems described above, an object of the present invention is to provide a hinge structure with an urging device for connecting a lid member and a container main body to open and close an opening of the container through a flapping movement. A damper function is provided for slowing a rotational movement, so that it is possible to prevent the lid member from rotating at a high speed.

Another object of the present invention is to provide a hinge unit having the hinge structure and a container having a lid member connected thereto through the hinge structure.

Further objects and advantages of the invention will be apparent from the following description of the invention.

### SUMMARY OF THE INVENTION

In order to solve the problems mentioned above, according to the present invention, a hinge structure rotatably connects one member to the other member. The hinge structure includes a hinge case attached to the one member; a first cam member disposed in the hinge case not to be rotatable and to be slidable; a second corn member disposed at one end portion of the hinge case to be rotatable and slidable; an urging device for urging the first member toward the one end portion of the hinge case; and a rotary damper including a rotor having a specific rotational resistance relative to a damper main body.

The second cam member has a cam surface at an end portion thereof in a sliding direction for abutting against a cam surface of the first cam member, and a connecting portion at the other end portion thereof protruding outwardly from an end 15, portion of the hinge case and connected to the other member not to be rotatable. One of the rotor and the dumper main body is connected to the hinge case not to be rotatable, and the other is disposed in the hinge case to be rotatable together with the second cam member.

When the one member rotates relative to the other member, the second cam member rotates together with the other member. With a cam function of the first and second cam members, the second cam member once retracts against an urging force of the urging device, and then advances with the urging force, so that the second cam member urges the one member and the other member to rotate. At a specific rotational angle, the first and second cam members engage with each other, and are held at the specific rotational angle. Further, the second cam member urges the one member and the other member to rotate slowly with damping effect of the rotary damper.

According to the present invention, a hinge unit is formed of the hinge structure in which the first cam member, the second cam member, the urging device, and the rotary damper are disposed in the hinge case.

According to the present invention, a lid member is attached to an opening of a container main body with the hinge structure for opening and closing the opening through a flapping movement. The hinge unit formed of the first cam member, the second cam member, the urging device, and the rotary damper is attached to one of the lid member and the container main body. The other of the lid member and the container main body is provided with a connecting recess portion. The connecting portion disposed on the second cam member of the hinge unit is inserted into the connecting recess portion, so that the lid member is rotatably connected to the container main body.

In the hinge structure of the invention, similar to a conventional hinge structure, when the one member is rotated relative to the other member by a specific angle, the cam effect of the first and second cam members converts the urging force of the urging device into a rotational force. Accordingly, the one member automatically rotates relative to the other member by a specific angle. At the specific angle, the cam surfaces of the first and second cam members engage with each other, thereby holding the one member and the other member are connected and held at the specific angle. Therefore, when the hinge structure is adapted to connect a lid member and a container main body, it is possible to automatically rotate the lid member to open or close, and stably hold the lid member in an opened state or a closed state.

In the hinge structure of the invention, the rotary damper with the rotor having specific rotational resistance relative to the damper main body is disposed in the hinge case. One of the rotor and the damper main body is attached to the hinge case not to be rotatable, and the other is arranged to rotate together with the second cam member. Accordingly, when the hinge case and the second cam member rotate together through the cam effect of the first and second cam members, the hinge case and the second cam member rotate slowly through the damper effect. As a result, the one member and the other member connected to the hinge case and the second cam member, respectively, rotate slowly through the damper effect.

In the hinge structure of the invention, when a lid member is attached to a container main body to form a container of an automobile, the lid rotate slowly, thereby improving operational performance. It is possible to prevent an impact due to a rapid rotation of the lid member. Further, the rotary damper is disposed in the hinge case, so that it is not necessary to provide a space of the damper in the lid member or the container main body.

In the present invention, the hinge unit is formed of the hinge structure in which the first cam member, the second cam member, the urging device, and the rotary damper are disposed in the hinge case. The hinge unit is attached to an attaching portion formed on one of the lid member and the container main body. The connecting portion disposed on the second cam member of the hinge unit is inserted into a connecting recess portion formed in the other, so that the hinge structure is easily provided. Accordingly, it is possible to easily assemble and install the container such as a small article box.

According to the present invention, when the lid member is attached to the container main body to form the container of an automobile, the lid rotate slowly, thereby improving operational performance. It is possible to prevent an impact due to a rapid rotation of the lid member. Further, the rotary damper is disposed in the hinge case, so that it is not necessary to provide a space of the damper in the lid member or the container main body.

### BRIEF DESCRIPTION OF THE DRAWINGS

FIG. 1 is a sectional view showing a hinge structure according to an embodiment of the present invention;

FIGS. 2(A) to 2(D) are views showing a hinge unit having the hinge structure in FIG. 1, wherein FIG. 2(A) is a plan view thereof, FIG. 2(B) is a front view thereof, FIG. 2(C) is a sectional view thereof taken along line 2(C)-2(C) in FIG. 2(A), and FIG. 2(D) is a bottom view thereof;

FIGS. 3(A) to 3(D) are views showing a hinge case of the hinge unit, wherein FIG. 3(A) is a plan view thereof, FIG. 3(B) is a front view thereof, FIG. 3(C) is a sectional view thereof taken along line 3(C)-3(C) in FIG. 3(A), and FIG. 3(D) is a bottom view thereof;

FIGS. 4(A) to 4(C) are views showing a first cam member of the hinge unit, wherein FIG. 4(A) is a plan view thereof, FIG. 4(B) is a front view thereof, and FIG. 4(C) is an exploded view thereof;

FIGS. 5(A) to 5(C) are views showing a second cam member of the hinge unit, wherein FIG. 5(A) is a plan view thereof, FIG. 5(B) is a front view thereof, and FIG. 5(C) is an exploded view thereof;

FIGS. 6(A) to 6(C) are views showing a rotary damper of the hinge unit, wherein FIG. 6(A) is a plan view thereof, FIG. 6(B) is a sectional view thereof taken along line 6(B)-6(B) in FIG. 6(A), and FIG. 6(C) is a side view thereof;

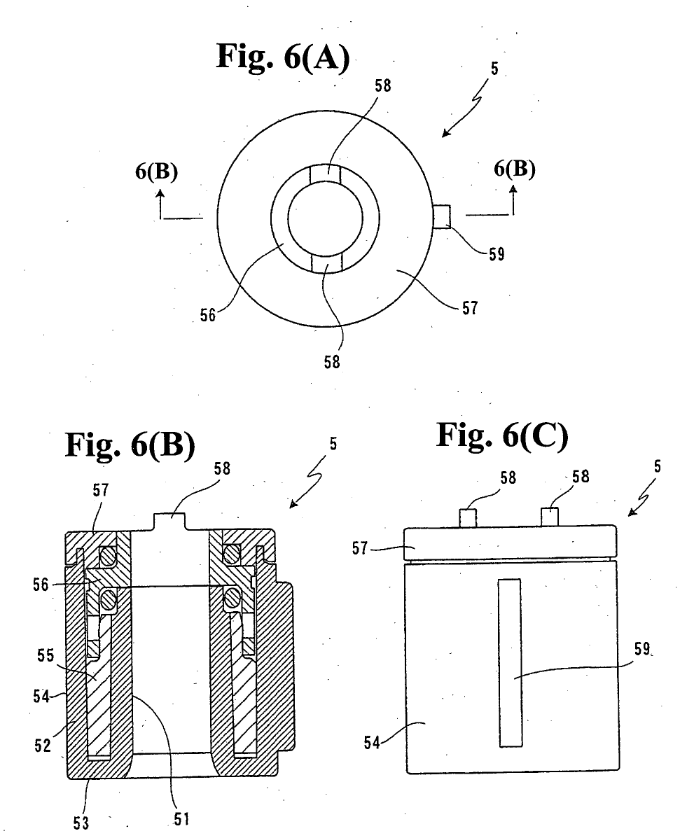

FIGS. 7(A) to 7(C) are views showing a connection piece of the hinge unit, wherein FIG. 7(A) is a perspective view thereof, FIG. 7(B) is a plan view thereof, and FIG. 7(C) is a sectional view thereof taken along line 7(C)-7(C) in FIG. 7(B);

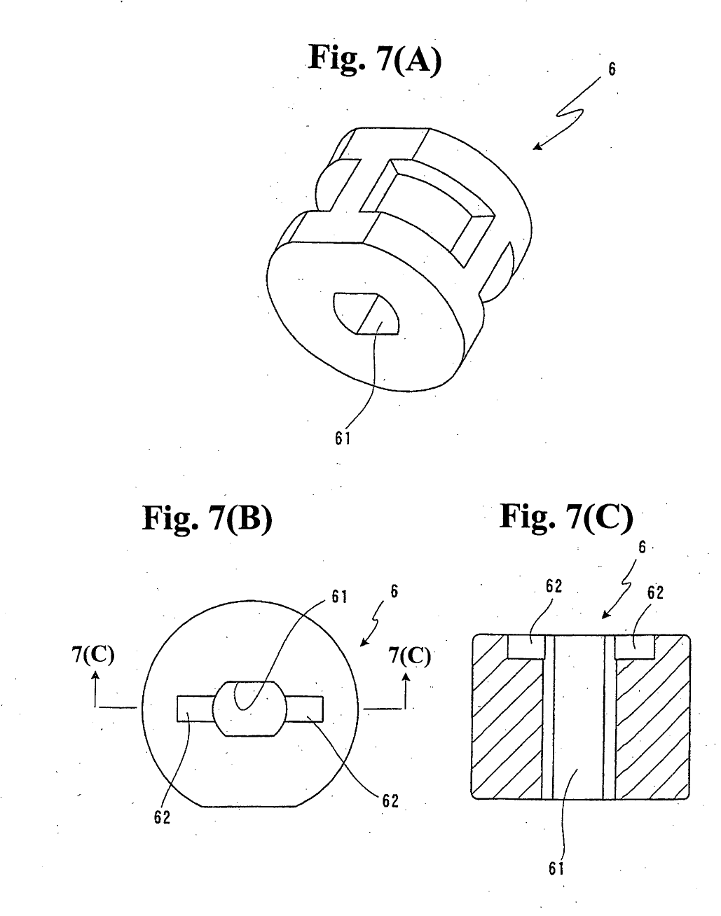

FIGS. 8(A) to 8(C) are views showing a shaft of the hinge unit, wherein FIG. 8(A) is a plan view thereof, FIG. 8(B) is a front view thereof, and FIG. 8(C) is a side view thereof; and

FIG. 9 is a view showing a container having the hinge structure;

FIGS. 10(A) to 10(F) are views showing an operation of the hinge structure, wherein FIGS. 10(A) to 10(C) are side views, and FIGS. 10(D) to 10(F) are views showing a relationship between the first and second cam members;

FIGS. 11(A) to 11(C) are views showing an operation of connecting a lid member to a container main body with the hinge structure;

FIGS. 12(A) and 12(B) are views showing a hinge structure according to another embodiment of the present invention, wherein FIG. 12(A) is a sectional view thereof, and FIG. 12(B) is a perspective view showing a first cam member integrated with a rotary damper of the hinge structure; and

FIG. 13 is a sectional view showing a conventional hinge structure.

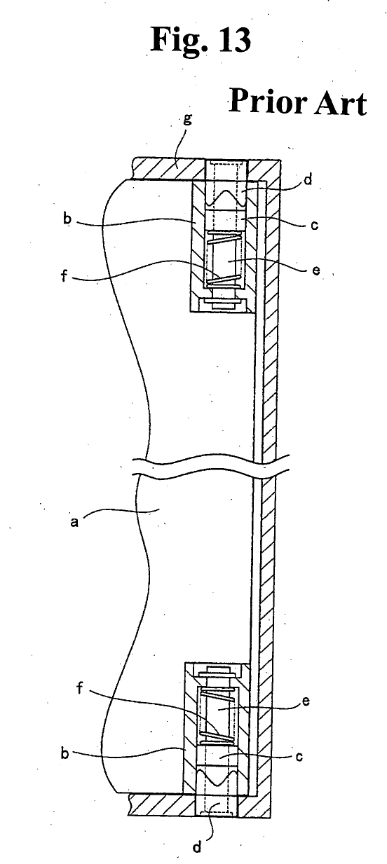

### DETAILED DESCRIPTION OF PREFERRED EMBODIMENTS

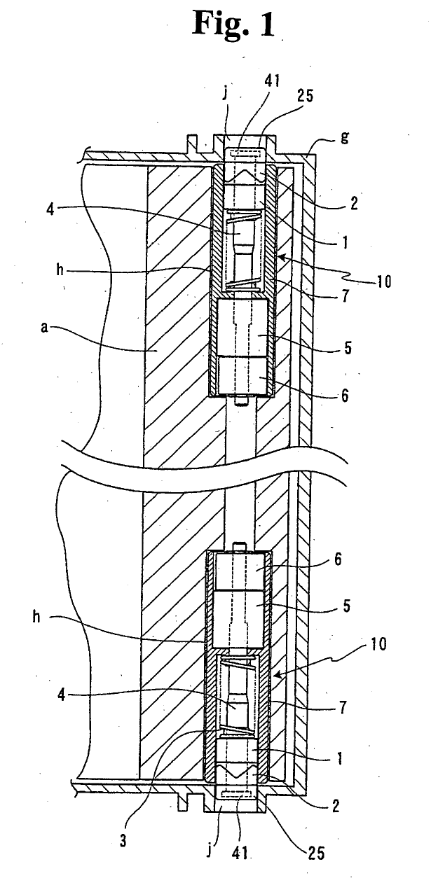

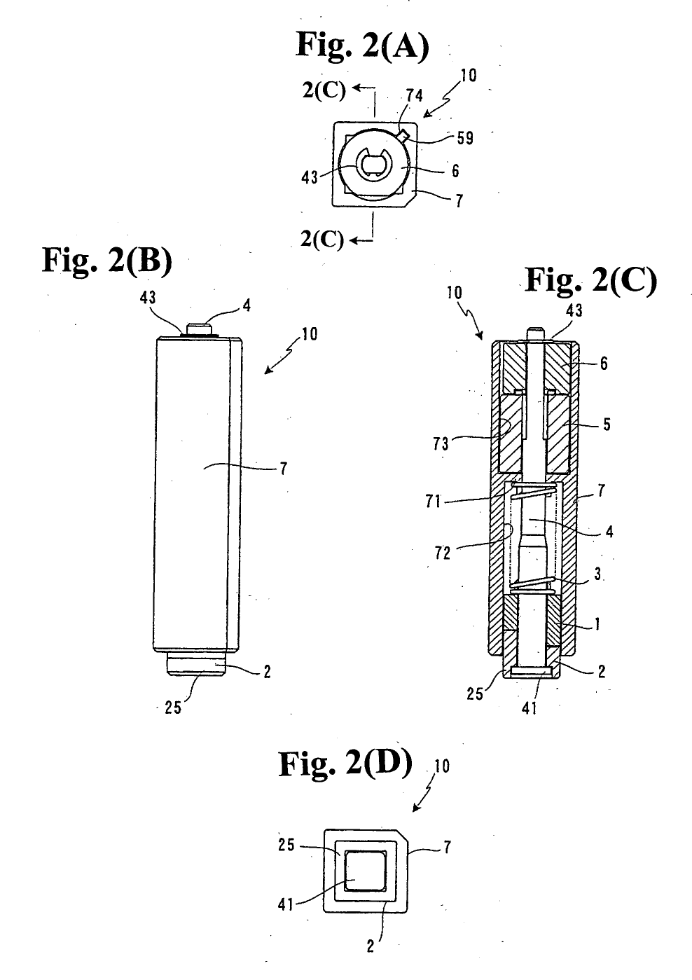

Hereinafter, embodiments of the present invention will be explained with reference to the accompanying drawings. FIG. 1 is a view showing a hinge structure according to an embodiment of the present invention for connecting a lid member a to a container main body g to be rotatable. In the hinge structure, hinge units 10 of the invention are attached to unit attaching portion h with a rectangular hole disposed at both sides of a base portion of the lid member a. Connection portions 25 are fitted in connection recess portions j with a rectangular hole formed in the container main body g. As shown in FIGS. 2(A) to 2(C), the hinge unit 10 includes a first cam member 1, a second cam member 2, a coil spring 3, a shaft 4, a rotary damper 5, and a connecting piece 6. The components are disposed in a hinge case 7.

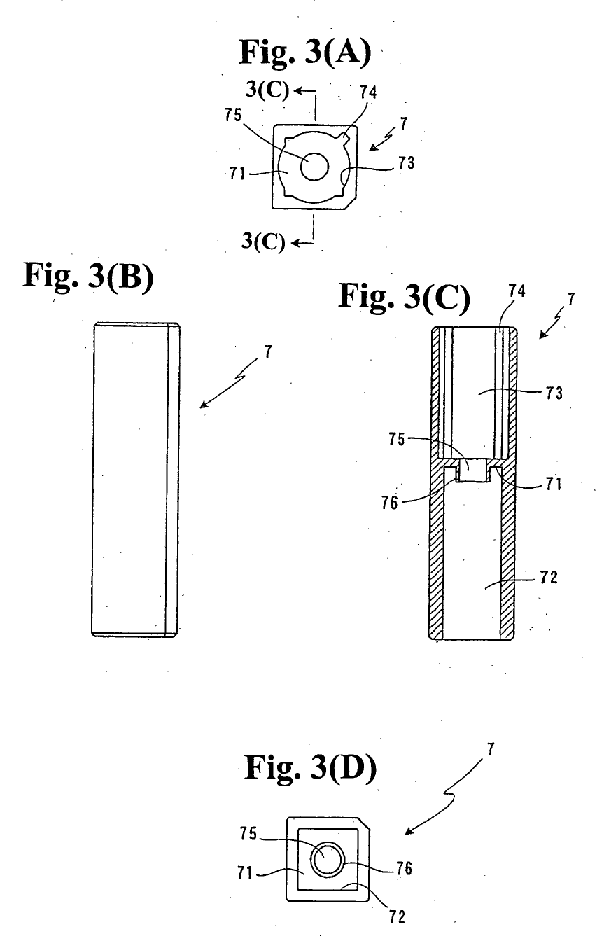

As shown in FIGS. 3(a) to 3(D), the hinge case 7 has a rectangular cylindrical shape, and interior thereof is divided with a partition wall 71. One side space is a cam retaining space 72, and the other side space is a damper space 73 having a circular section. The damper space 73 is provided with a rectangular groove 74 extending in an axial direction at a portion and an inner surface. A protrusion 59 of the damper main body (described alter) is fitted in the rectangular groove 74. The partition wall 71 has a through-hole 75 at a center portion thereof. A cylindrical protrusion 76 having an interior communicating with the through-hole 75 protrudes from the partition wall 71 into the cam retaining space 72.

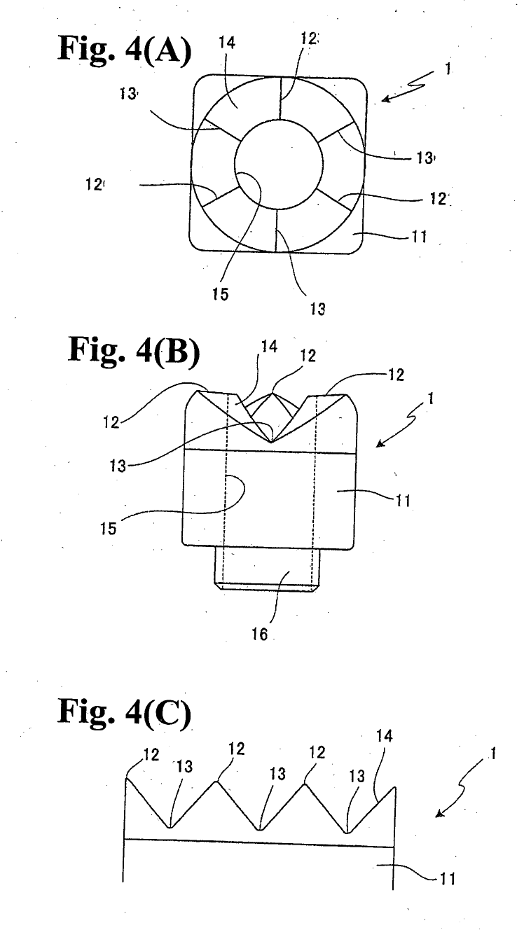

As shown in FIGS. 4(A) to 4(C), the first cam member 1 has a rectangular block main body 11, and a cam surface 14 is formed on a surface of the rectangular block main body 11. The cam surface 14 has three mountain portions 12 and three valley portions 13 connected alternately in a ring shape. The first cam member 1 is provided with a shaft insertion hole 15 penetrating the rectangular block main body 11 and opening in the cam surface 14. A cylindrical protrusion 16 communicating with the shaft insertion hole 15 protrudes from a center of an end surface of the rectangular block main body 11.

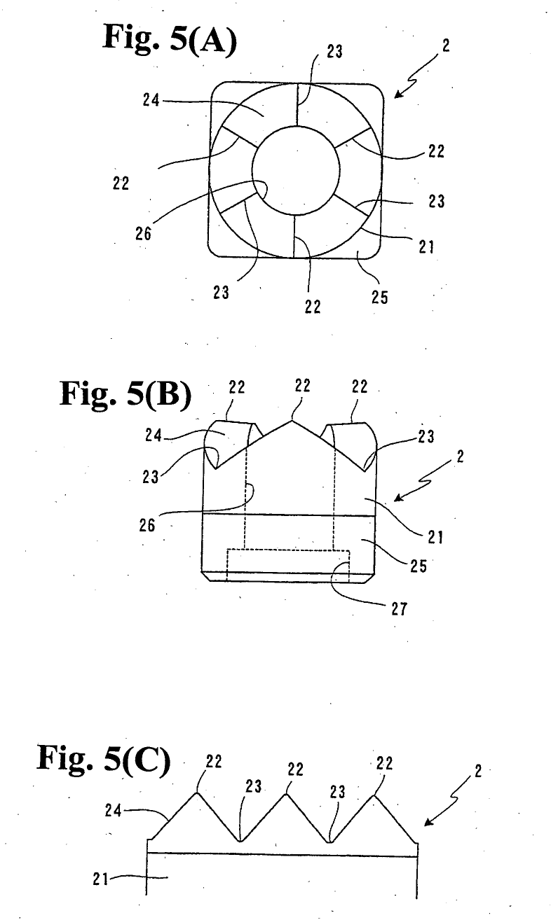

As shown in FIGS. 5(A) to 5(C), the second cam member 2 has a cylindrical main, body 21, and a cam surface 24 is formed on one surface of the cylindrical main body 21. The cam surface 24 has three mountain portions 22 and three valley portions 23 connected alternately in a ring shape. A connecting portion 25 with a cylindrical block shape is integrated with the other surface of the main body 21. The second cam member 2 is provided with a shaft insertion hole 26 penetrating the main body-21 and the connecting portion 25. A flange fitting portion 27 with a partially rectangular large diameter is formed at an opening of the shaft insertion hole 26 on a side of the connecting portion 25.

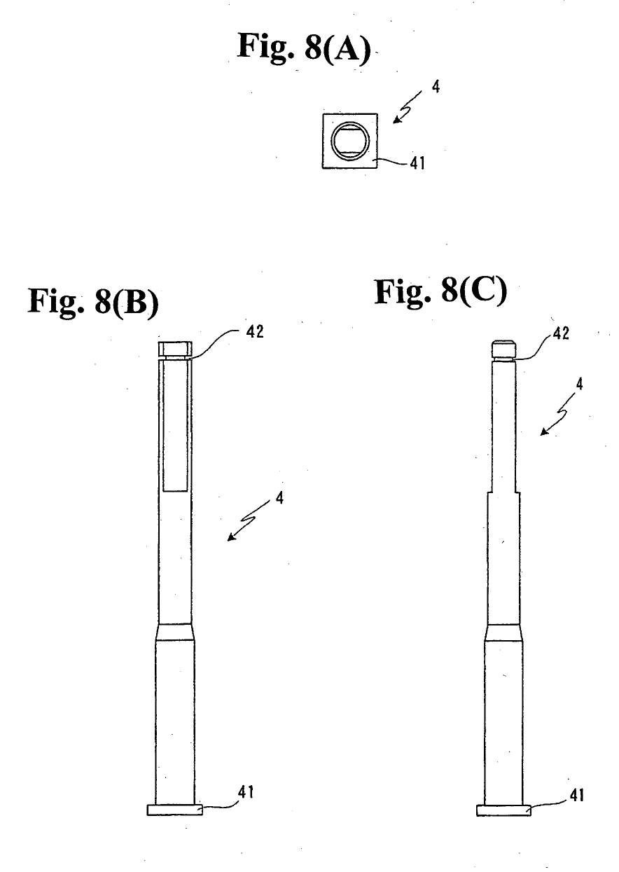

As shown in FIGS. 8(A) to 8(C), the shaft 4 has a rectangular flange 4 at one end portion thereof for preventing pulling-out. The shaft 4 has a large diameter from a center portion thereof to the one end portion, and a small diameter from the center portion to the other end portion. The shaft 4 also includes two cutout portions in a peripheral surface thereof at opposing positions within a specific area on the other end portion. A ring groove 42 is formed in the peripheral surface on the other end portion for inserting an E-ring 43 for preventing pulling-out.

The rotary damper 5 has a damper main body 54 with a cylindrical shape formed of an inner cylinder 51 and an outer cylinder 52 connected with a bottom wall 53 with a ring shape. A space between the inner cylinder 51 and the outer cylinder 52 is filled with viscous fluid for generating resistance to a rotational movement of a rotor 55. A connection ring 56 with a short cylindrical shape is attached to an upper portion of the rotor 55, so that the connection ring 56 rotates together with the rotor 55. A cap 57 with a ring plate shape closes an upper end surface of the damper main body 54. Two connecting protrusions 58 protrude from the connection ring 56 through the upper end surface of the damper main body 54. The rotary damper 5 has a through-hole with a circular shape at a center portion thereof, and a protruding portion 59 protrudes from outer surface of the damper main body 51 along an axial direction for preventing slipping.

The connecting piece 6 is formed in a cylindrical block shape having a through-hole 61 with a section having a shape same as the end portion of the shaft 4. Engaging recess portions 62 are formed in an end surface of the connecting piece 6 with the through-hole 61 in between for engaging the connecting protrusions 58 of the connecting ring 56 of the rotary damper 5.

As shown in FIG. 2, the second cam member 2, the first cam member 1, and the coil spring 3 are sequentially retained in the cam retaining space 72 of the hinge case 7 from the open end, and the rotary damper 5 and the connecting piece 6 are sequentially retained in the damper space 72 from the partition wall side. The shaft 4 is inserted into the first cam member 1, the coil spring 3, the through-hole 75 of the partition wall 71, the rotary damper 5, and the connecting piece 6, so that the rectangular flange 41 of the shaft 4 is fitted in the flange fitting portion 27 of the second cam member 2. Further, the E-ring 43 (flange for preventing pulling out) is attached to the ring groove 42 at the end portion of the shaft 4 outside the connecting piece 6, so that the components are assembled in the hinge case 7 to constitute the hinge unit 10 with the first cam member 1, the second cam member 2, the coil spring 3, the shaft 4, the rotary damper 5, the connecting piece 6, and the hinge case 7.

The rectangular block main body 11 of the first cam member 1 is retained in the cam retaining space 72 of the hinge case 7 with the rectangular section not to rotate. In the non-rotatable state, the rectangular block main body 11 is retained in the cam retaining space 72 of the hinge case 7 to be slidable, and is urged toward the open end with the coil spring 3 to be rotatable relative to the shaft 4. In the state that the cam surface 24 of the second cam member 2 faces the cam surface 14 of the first cam member 1, only the cylindrical main body 21 of the second cam member 2 is inserted into the cam retaining space 72 of the hinge case 7, and the connecting portion 25 protrudes outwardly from the end surface of the hinge case 7. In this state, the second cam member 2 is rotatable and slidable relative to the hinge case 7, and is urged toward outside through the first cam member 1 with the coil spring 3. In the state that the connecting portion 25 protrudes from the hinge case 7, the rectangular flange 41 of the shaft 4 engages the second cam member 2 not to be rotatable relative to the shaft 4.

Further, the protruding portion 59 of the rotary damper 5 is inserted into the rectangular groove 74 formed in the inner surface of the damper space 72, so that the rotary damper 5 is not rotatable relative to the hinge case 7 and rotatable relative to the shaft 4. The engaging recess portions 62 of the connecting piece 6 engage the connecting protrusions 58 of the connecting ring 56 of the rotary damper 5, so that the connecting piece 6 is not rotatable relative to the shaft 4 and rotatable relative to the hinge case 7.

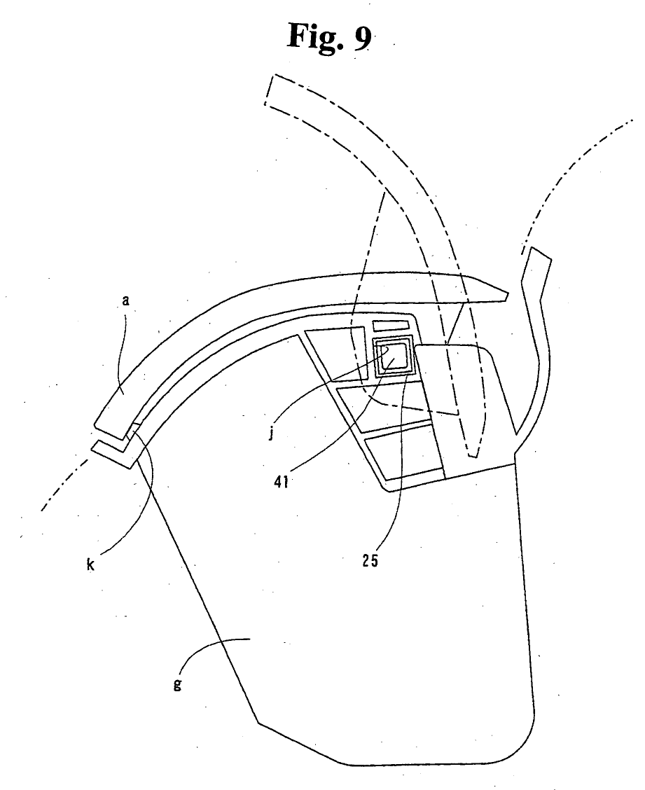

In the hinge structure in the embodiment, as shown in FIGS. 1 and 9, the hinge units 1 are attached to the unit attaching portion h with a rectangular hole disposed at both sides of the base portions of the lid member a. The connection portion 25 of the second cam member 2 protruding from the end surface of the hinge case 7 is fitted in the connection recess portion j with a rectangular hole formed in a side surface of the container main body g. The connection portion 25 of the second cam member 2 is formed in the rectangular block shape and engages the connection recess portion j, so that the second cam member 2 is not rotatable relative to the container main body g.

As shown in FIG. 9, the container has the lid member a attached to the container main body g with the hinge structure. When the lid member a is rotated upwardly with a finger hooking on a finger hooking portion thereof (not shown) from the closed state that the front edge of the lid member a abuts against a cushion member k on an opening edge of the container main body g, the lid member a stands up by 90 degrees in the open state indicated by the projected line in FIG. 9. From the open state, the lid member a is rotated forward to return to the closed state, thereby performing the opening and closing operation.

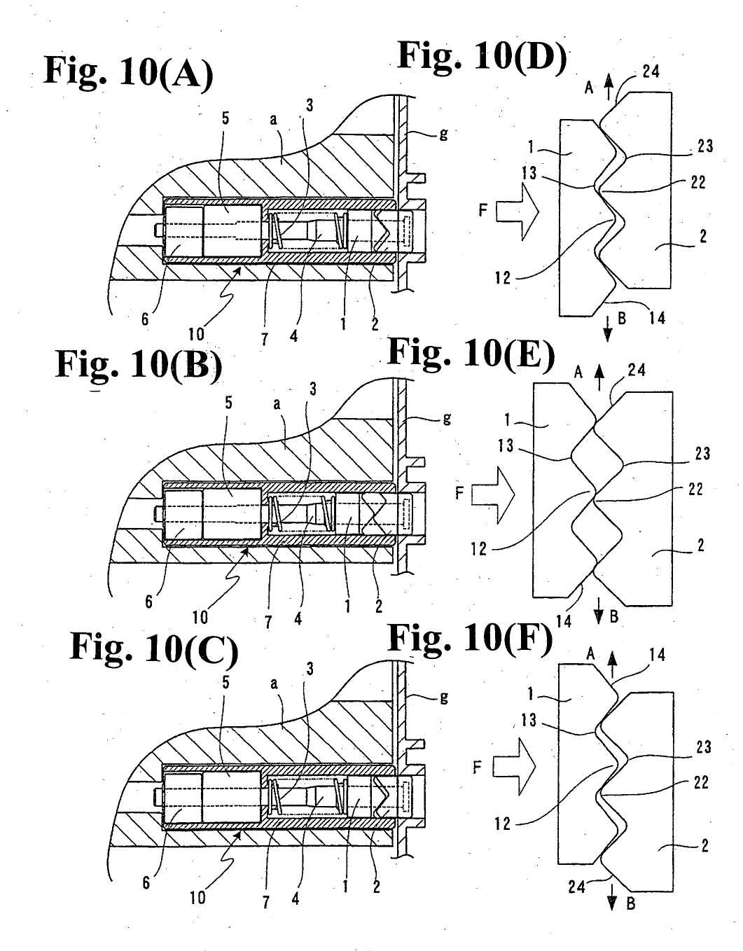

In the closed state indicated by the solid line in FIG. 9, the mountain portions 12 and 13 of the cam surface 14 of the first cam member 1 do not completely engage and are shifted relative to the valley portions 22 and 23 of the cam surface 24 of the second cam member 2 as shown in FIGS. 10(A) and 10(D). Accordingly, with the cam effect of the first cam member 1 and the second cam member 2, the urging force F of the coil spring 3 is converted into the force for rotating the first cam member 1 and the second cam member 2 in opposite directions, thereby urging the first cam member 1 in the arrow direction B and the second cam member 2 in the arrow direction A in FIG. 10(D), respectively.

The connection portion 25 of the second cam member 2 engages the connection recess portion j of the container main body g, so that the second cam member 2 is not rotatable relative to the container main body g, while the first cam member 1 is rotatable relative to the hinge case 7. Accordingly, the rotational force applied to the first cam member 1 and the second cam member 2 is applied to the hinge case 7 to rotate in one direction, so that the lid member a attached to the hinge case 7 is urged to rotate in one direction relative to the container main body g. In the embodiment, the urging force rotates the lid member a in the closing direction, so that the lid member a is held without rattle in the closed state shown in FIG. 9.

From this state, when the lid member a is rotated in the opening direction against the urging force, the first cam member 1 rotates in the arrow direction A relative to the second cam member 2 against the urging force F of the coil spring 3 from the state shown in FIGS. 10(A) and 10(D). When the lid member a is rotated by a specific angle, the tops of the mountain portions 12 and 13 on the cam surface 14 of the first cam member 1 move over the tops of the mountain portions 22 and 23 on the cam surface 24 of the second cam member 2 to opposite sides as shown in FIGS. 10(B) and 10(E). In this state, the urging force F of the coil spring 3 is converted into the force for rotating the first cam member 1 relative to the second cam member 2 in the arrow direction A, thereby rotating the first cam member 1 relative to the second cam member 2 in the arrow direction A. Accordingly, the lid member a automatically rotates up to the opening limit indicated by the projected line in FIG. 9, thereby opening the container main body g.

At this time, in the first cam member 1 and the second cam member 2, the mountain portions 12 and 13 on the cam surface 14 of the first cam member 1 are about to engage the mountain portions 22 and 23 on the cam surface 24 of the second cam member 2. The lid member a is urged in the closing direction at the opening limit, so that the lid member a is held without rattle in the opened state shown in FIG. 9.

When the lid member a is rotated in the closing direction by a specific angle with a finger against the urging force from the state indicated by the projected line in FIG. 9, the lid member a returns from the opened state to the closed state. Through the operation same as the opening operation except that the opening and urging directions are reversed, the lid member a automatically rotates in the closing direction and returns to the closed state indicated by the solid line in FIG. 9. That is, when the lid member a is rotated in the closing direction, the first cam member 1 rotates in the arrow direction B shown in FIG. 10(F). When the tops of the mountain portions 12 and 13 on the cam surface 14 of the first cam member 1 move over the tops of the mountain portions 22 and 23 on the cam surface 24 of the second cam member 2, with the cam effect of the first cam member 1 and the second cam member 2, the urging force F of the coil spring 3 is converted into the force for rotating the first cam member 1 in the arrow direction B and rotating the lid member a in the closing direction. Accordingly, the lid member a automatically rotates in the closing direction and returns to the closed state indicated by the solid line in FIG. 9 and as shown in FIGS. 10(A) and 10(D).

When the lid member a rotates, the second cam member 2 rotates relative to the hinge case 7, and the shaft 4 fixed to the second cam member 2 rotates relative to the hinge case 7. The connecting piece 6 fixed to the shaft 4 rotates together with the second cam member 2 and the shaft 4, and the rotor 55 of the rotary damper 5 fixed to the connecting piece 6 also rotates. The damper main body 54 of the rotary damper 5 engages the hinge case 7 not to be rotatable. When the rotor 55 rotates, the rotational resistance is generated with the damper effect of the rotary damper 5, so that the lid member a is damped while rotating. Accordingly, the lid member a automatically opens and closes slowly with the urging force of the coil spring 3 and the cam effect of the first cam member 1 and the second cam member 2.

As described above, when the container has the lid member a attached to the container main body g with the hinge structure of the invention, it is possible to open and close the lid member a with one touch operation as the lid member a automatically rotates by rotating by a specific angle in the opening or closing direction. With the damper effect, the lid member a rotates slowly, thereby improving operation performance and preventing an impact due to rapid rotation of the lid member a. The rotary damper 5 is disposed in the hinge case 7, so that it is not necessary to provide a space in the lid member a or the container main body g for installing the damper. The lid member a is held in the opened state with the urging force of the coil spring 3 and the cam effect of the first cam member 1 and the second cam member 2, and the lid member a does not rattle in the opened and closed states.

In the hinge structure in the embodiment, the second cam member 2 is slidable relative to the hinge case 7, and is urged toward the one end portion of the hinge case 7 together with the first cam member 1 with the urging force of the coil spring 3, so that the connecting portion 25 on the second cam member 2 protrudes outwardly from the one end portion of the hinge case 7. Accordingly, when the connecting portion 25 is pushed to slide the second cam member 2 toward the other end portion of the hinge case 7 against the urging force of the coil spring 3, the connecting portion 25 is pushed into the hinge case 7, so that the lib member a is attached to the container main body g with good operational performance.

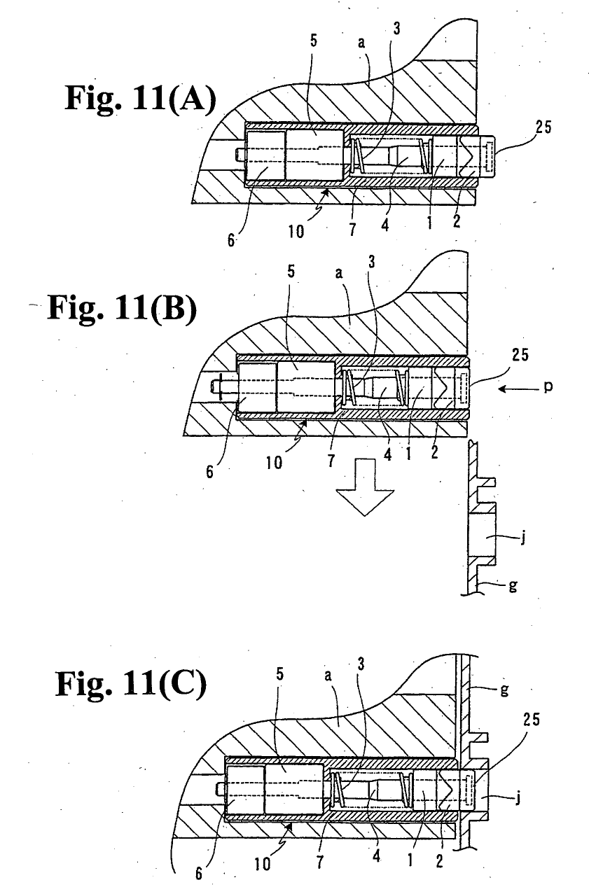

As shown in FIG. 11(A), before the lib member a is attached to the container main body g, the connecting portion 25 on the second cam member 2 protrudes outwardly from the one end portion of the hinge case 7. When the lib member a is attached to the container main body g, the connecting portion 25 of the second cam member 2 is inserted into the connecting recess portion j of the container main body g. In this case, as shown in FIG. 11(B), the connecting portion 25 on the second cam member 2 protruding outwardly from the one end portion of the hinge case 7 is pushed with a pushing force p to be inserted into the hinge case 7 against the urging force of the coil spring 3. At this time, as shown in FIG. 11(B), the first cam member 1 and the shaft 4 slide backward together with the second cam member 2, and the end of the hinge case 7 protrudes backward from the rear end of the hinge case 7.

In this state, as shown in the arrow in FIG. 11(B), the lid member a is arranged at a specific position in the container main body g, so that the end portion of the hinge case 7 (open end where the connecting portion 25 is pushed in) is aligned with the connecting recess portion j of the container main body g. Then, the pushing force p is released (normally, the pushing force is automatically released when the lid member a is precisely arranged), so that the connecting portion 25 of the second cam member 2 protrudes from the one end portion of & with the urging force of the coil spring 3. Accordingly, as shown in FIG. 11(C), the connecting portion 25 is inserted into the connecting recess portion j of the container main body g, and the lib member a is attached to the container main body g. In the embodiment, the hinge units 10 are disposed on the both sides of the lid member a, and the same operation is applied to both of the hinge units 10 at the same time.

As described above, in the state that the connecting portion 25 of the hinge unit 10 attached to the lid member a is pushed into the hinge case 7, the lid member a is easily attached to the container main body g with the simple operation to form the container with the lid. The hinge structure is unitized as the hinge unit 10 to be attached to a specific location of the lid member a, so that the lid member a is easily attached to the container main body g with the simple operation.

In the present invention, the hinge structure, the hinge unit, and the container are not limited to the embodiments, and may be modified as necessary. For example, in the embodiment, the rotary damper 5 is attached to the shaft 4 not to be rotatable with the connecting piece 6, and is connected to the second-cam member 2 with the shaft 4. Alternatively, the rotary damper may be integrated with the first cam member 1, thereby reducing the number and sizes of parts, and making the structure simple.

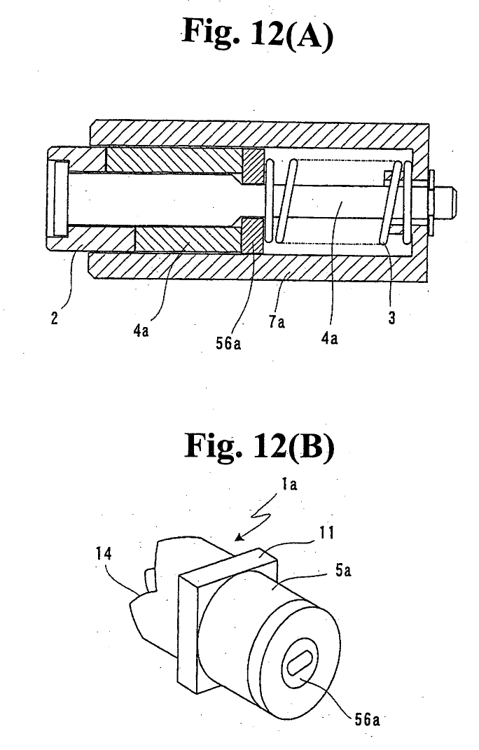

As shown in FIG. 12(B), a rotary damper 5a is integrated with a lower surface of a rectangular block main body 11 of a first cam member 1a. A connecting ring 56a connected to a rotor of the rotary damper 5a is provided with a through-hole for connecting a shaft 4a not to be rotatable. As shown in FIG. 12(A), the shaft 4a is connected to the through-hole of the connecting ring 56a not to be rotatable, thereby eliminating the damper space 72 and the connecting piece 6 in the embodiment described above. The rotary damper 5a is integrated with the first cam member 1a, thereby making the unit simple and small. The operation and effect are the same as those of the unit 10 described above.

According to the invention, the hinge unit is suitable for connecting the lid member to the container main body to form the container with the lid, especially a cup holder- or a small article box as an interior device of an automobile. The application is not limited thereto, and includes a cover of a vanity mirror disposed on a back surface of a sun visor or a flap of a mobile phone, in which two members are rotated through a flapping movement.

The disclosure of Japanese Patent Application No. 2004-223828, filed on Jul. 30, 2004, is incorporated in the application.

While the invention has been explained with reference to the specific embodiments of the invention, the explanation is illustrative and the invention is limited only by the appended claims.

What is claimed is:

1. A hinge structure for rotatably connecting one member to the other member, comprising:
a hinge case to be attached to the one member,
a first cam member slidably disposed in the hinge case without rotating thereto, and having a first cam surface,
a second cam member slidably and rotatably disposed at one end portion of the hinge case, said second cam member having a second cam surface at an end portion thereof in a sliding direction for abutting against the first cam surface of the first cam member, and a connecting portion at the other end portion thereof protruding outwardly from the one end portion of the hinge case to be attached to the other member not to rotate,
an urging device for urging the first cam member toward the one end portion of the hinge case, and
a rotary damper having a damper main body and a rotor for generating a specific rotational resistance relative to the damper main body, one of said rotor and said dumper main body being connected to the hinge case not to rotate, and the other of said rotor and said dumper main body being disposed in the hinge case to be rotatable together with the second cam member.

2. A hinge structure according to claim 1, wherein said first and second cam members are arranged such that when the one and the other members are relatively rotated, the second cam member rotates together with the other member while the second cam member retreats against an urging force of the urging device by cam operations of the first and second cam members, and advances again by the urging force to thereby rotate the one and the other members relatively with a damping force of the rotary damper; and said first and second cam surfaces engage together at a predetermined engaging state in a predetermined rotational angle between the one and the other members to thereby hold the one and the other members.

3. A hinge structure according to claim 1, wherein said first cam member includes a first block main body with a rectangular shape having the first cam surface on one end surface thereof, said first cam surface having mountain portions and valley portions extending in a ring shape, and said second cam member includes a second block main body with a cylindrical shape having the second cam surface on one end surface thereof and the connecting portion with a cylindrical shape connected to the other end surface thereof, said second cam surface having mountain portions and valley portions extending in a ring shape.

4. A hinge structure according to claim 3, wherein said hinge case has a rectangular hollow shape to receive the first and second cam members, said connecting portion of the second cam member being located in a connecting recess portion with a rectangular shape.

5. A hinge structure according to claim 1, wherein said hinge case has a cylindrical shape with a wall at one portion thereof, said hinge structure further comprising a shaft extending along an axial direction of the hinge case and penetrating through the wall, the rotary damper, and the first and second cam members, said shaft having flange portions at two ends thereof for preventing pulling out.

6. A hinge structure according to claim 5, wherein said rotary damper includes a damper main body with a cylindrical shape immovably attached to the hinge case, and a rotor disposed in the damper main body and fixed to the shaft, said second cam member being fixed to the shaft so that the rotor rotates together with the second cam member through the shaft.

7. A hinge structure according to claim 5, wherein said rotary damper includes a damper main body integrated with the first cam member, and a rotor for generating rotational resistance relative to the damper main body, said shaft being fixed to the rotor and second cam member so that the rotor rotates together with the second cam member through the shaft.

8. A hinge unit comprising the hinge structure according to claim 1.

9. A container comprising the hinge structure according to claim 1, a container main body with an opening, and a lid member for opening and closing the opening, said hinge structure being attached to one of the container main body and the lid member, and the other of the container main body and the lid member including a connecting recess portion for receiving the connecting portion so that the lid member is rotatable attached to the container main body.
